(19) United States
(12) Patent Application Publication
(10) Pub. No.: US 2025/0280012 A1
(43) Pub. Date: Sep. 4, 2025

(54) INFORMATION PROCESSING APPARATUS, CONTROL METHOD FOR INFORMATION PROCESSING APPARATUS, AND STORAGE MEDIUM

(71) Applicant: CANON KABUSHIKI KAISHA, Tokyo (JP)

(72) Inventor: YUKI MINETOMO, Kanagawa (JP)

(21) Appl. No.: 19/063,926

(22) Filed: Feb. 26, 2025

(30) Foreign Application Priority Data
Mar. 1, 2024 (JP) 2024-031612

(51) Int. Cl. H04L 9/40

(52) U.S. Cl. CPC H04L 63/1416; H04L 63/0236; H04L 63/1441

(57) ABSTRACT

An information processing apparatus includes a detection unit configured to detect unauthorized access to the information processing apparatus; a blocking unit configured to block the unauthorized access; a restricting unit configured to restrict functions of the information processing apparatus; an identifying unit configured to identify a source of the unauthorized access based on a state of access to the restricted functions; a countermeasure unit configured to perform a countermeasure based on information on the source of the unauthorized access; and a canceling unit configured to cancel the restricting of the functions after the countermeasure has been performed.

### BACKGROUND

### Technical Field

The present disclosure relates to an information processing apparatus, a control method for an information processing apparatus, and a storage medium.

### Description of the Related Art

Damage caused by cyberattacks targeting information processing apparatuses has been trending upwards in recent years. Although various security countermeasures are being implemented in response, cyberattacks are becoming more sophisticated, making it more and more difficult to counter them using conventional security countermeasures such as malware detection and firewalls. Attacks that exploit unknown vulnerabilities, called “zero-day attacks”, are particularly difficult to defends against. For example, there have been scattered examples of attackers using zero-day attacks to infiltrate and exploit the systems of information processing apparatuses to the detriment of individuals and companies.

In addition to conventional defenses against such sophisticated attacks at network boundaries, security countermeasures such as monitoring system behavior and detecting attacks that attempt to exploit the system are becoming more common. Such security countermeasures are realized by Endpoint Detection and Response (EDR), which is a publicly-known technology, and are widely used in personal computers (PCs).

When the behavior of an attacker is detected through EDR, the terminal being targeted by the attack is typically isolated from the network to protect assets such as other terminals and servers. In this case, the terminal cannot be used until the attacker's intrusion route and attack method can be identified. This identification can take time even for an expert, meaning that it may not be possible to perform any tasks for an extended period of time.

Japanese Patent Laid-Open No. 2023-137656 discloses a technique in which when a computer virus is detected in an information processing apparatus, functions to be restricted and functions to be allowed to use are identified according to the type of the computer virus, the location of the infection, and the like. Through this, functions unrelated to damage caused by the computer virus can be used, while preventing a situation where the information processing apparatus under attack becomes completely unusable. In addition, the virus is removed after being detected, and the restrictions are relaxed in stages as the removal progresses. This reduces the impact that restricting functions has on the usability.

However, with Japanese Patent Laid-Open No. 2023-137656, in an attack in which an attacker remotely accesses the information processing apparatus and performs unauthorized operations on the system of the information processing apparatus, the behavior of the attacker cannot be uniquely identified, and thus the functions to be prohibited cannot be identified. Furthermore, with Japanese Patent Laid-Open No. 2023-137656, a virus can be identified at the detection stage, and the removal is performed in accordance with the virus. However, in the case of unauthorized access, the method of intrusion cannot be identified, and thus no countermeasures can be taken. Accordingly, even if an attack has been detected and restrictions have been successfully imposed on functions, there are no indicators for relaxing the restrictions, meaning that the functions will remain restricted. In addition, although countermeasures such as EDR are widely used in PCs and the like, such countermeasures require certain resources to use, and are therefore unrealistic for adoption in IoT devices with limited resources. In other words, the technique disclosed in Japanese Patent Laid-Open No. 2023-137656 has a problem in that it is difficult to prevent the spread of damage while maintaining some functions of an information processing apparatus during unauthorized access.

### SUMMARY

Having been conceived in light of the aforementioned problem, the present disclosure provides a technique for preventing the spread of damage while maintaining some functions of an information processing apparatus during unauthorized access.

According to one aspect of the present disclosure, there is provided an information processing apparatus comprising: at least one memory storing instructions; and at least one processor that, upon execution of the stored instructions, is configured to operate as: a detection unit configured to detect unauthorized access to the information processing apparatus; a blocking unit configured to block the unauthorized access; a restricting unit configured to restrict functions of the information processing apparatus; an identifying unit configured to identify a source of the unauthorized access based on a state of access to the restricted functions; a countermeasure unit configured to perform a countermeasure based on information on the source of the unauthorized access; and a canceling unit configured to cancel the restricting of the functions after the countermeasure has been performed.

Further features of the present disclosure will become apparent from the following description of exemplary embodiments (with reference to the attached drawings).

### BRIEF DESCRIPTION OF THE DRAWINGS

FIG. 1 is a block diagram illustrating the connection between an MFP and a peripheral device according to a first embodiment.

FIG. 2 is a diagram illustrating the hardware configuration of a controller unit of the MFP according to the first embodiment.

FIG. 3 is a diagram illustrating the functional configuration of the controller unit of the MFP according to the first embodiment.

FIG. 4 is a diagram illustrating an example of a startup control table according to the first embodiment.

FIG. 5 is a diagram illustrating an example of an unauthorized access log record table according to the first embodiment.

FIG. 6 is a flowchart illustrating a processing sequence performed by the MFP according to the first embodiment.

FIG. 7 is a diagram illustrating the functional configuration of the controller unit of the MFP according to a first variation on the first embodiment.

FIG. 8 is a flowchart illustrating a processing sequence performed by the MFP according to the first variation on the first embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

The present embodiment will describe processing that, by restricting only functions exploited by an attacker when unauthorized access to an information processing apparatus is detected, prevents the spread of damage while maintaining basic functions. Although the present embodiment will describe a multi-functional peripheral (MFP), which is an image forming apparatus, as an example of the information processing apparatus, the present embodiment can also be applied in an information processing apparatus aside from an MFP.

### System Configuration

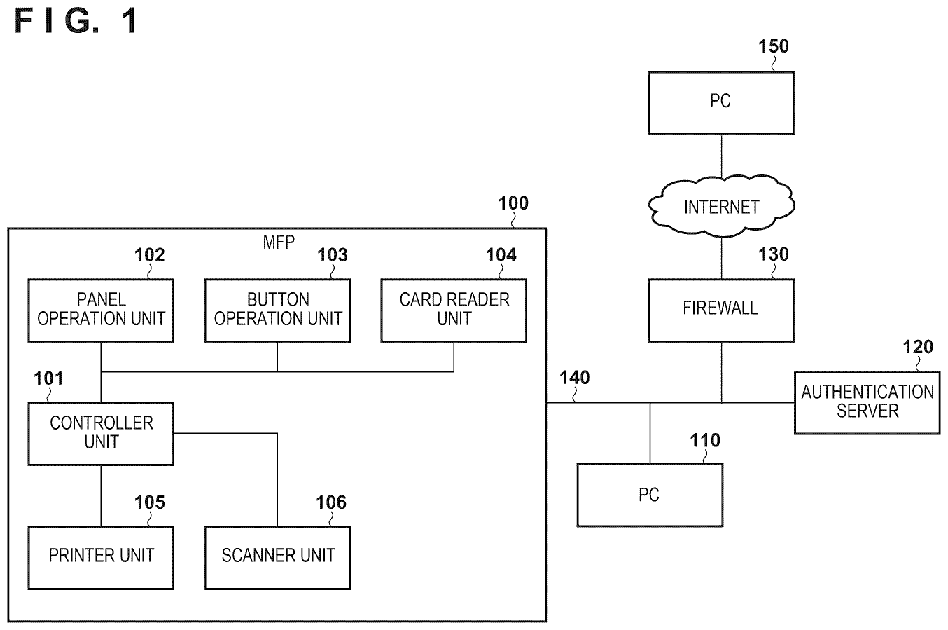

The connection between an MFP and a peripheral device according to the present embodiment will be described with reference to FIG. 1. An MFP 100, a personal computer (PC) 110, and an authentication server 120 are connected over a LAN 140. The PC 110 performs processing such as sending and receiving print jobs, scan jobs, and the like to and from the MFP 100. The authentication server 120 authenticates and authorizes users accessing the MFP 100. A protocol such as Lightweight Directory Access Protocol (LDAP) is used for the authentication. When the MFP 100 or the PC 110 connects to the Internet, the connection is made through a firewall 130. The PC 110 can access the MFP 100 over the Internet.

The MFP 100 includes a controller unit 101, a panel operation unit 102, a button operation unit 103, a card reader unit 104, a printer unit 105, and a scanner unit 106. The controller unit 101 controls various operations of the MFP 100. The panel operation unit 102 makes inputs and outputs with a user. The panel operation unit 102 is constituted by an electronic panel, and enables the MFP to be operated by a user making touch inputs. The button operation unit 103 also makes inputs and outputs with a user. The button operation unit 103 is constituted by physical buttons, and enables the MFP to be operated by a user pressing those buttons. The card reader unit 104 enables a user to be authenticated by the user holding an IC card up thereto. The printer unit 105 outputs electronic data onto a paper medium. The scanner unit 106 reads a paper medium to convert the content thereof into electronic data. The panel operation unit 102, the button operation unit 103, the card reader unit 104, the printer unit 105, and the scanner unit 106 are connected to the controller unit 101, and realize the functions of the MFP under the control of the controller unit 101.

### Hardware Configuration

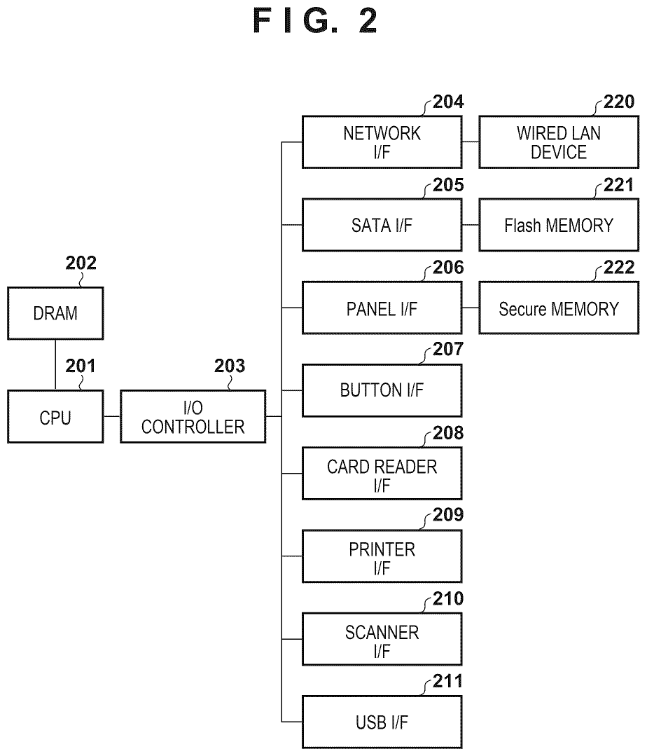

FIG. 2 is a block diagram illustrating an example of the hardware configuration of the controller unit 101 of the MFP according to the present embodiment. A CPU 201 performs the main computational processing in the controller unit 101. The CPU 201 is connected to a DRAM 202 by a bus. The DRAM 202 is used by the CPU 201 as a working memory for temporarily holding program data expressing computation commands, data to be processed, and the like during computations by the CPU 201.

The CPU 201 is connected to an I/O controller 203 by a bus. The I/O controller 203 makes inputs and outputs to various devices in accordance with instructions from the CPU 201. A network I/F 204 is connected to the I/O controller 203. A wired LAN device 220 is connected to the network I/F 204. The CPU 201 communicates over the LAN 140 by controlling the wired LAN device 220 through the network I/F 204.

A Serial Advanced Technology Attachment (SATA) I/F 205 is connected to the I/O controller 203, and a Flash memory 221 and a Secure memory 222 are connected thereto. The CPU 201 uses the Flash memory 221 for permanently storing programs for implementing the functions of the MFP and document files. The CPU 201 also uses the Secure memory 222 to store data critical for security. The Secure memory 222 is encrypted and can only be accessed from specific modules through access control. This protects from leakage or unauthorized alteration of sensitive information.

A panel I/F 206 is connected to the I/O controller 203. The panel I/F 206 implements user operations by converting physical operations by a user, input through the panel operation unit 102, into electronic data and communicating that electronic data to the CPU 201. A button I/F 207 is connected to the I/O controller 203. The button I/F 207 implements user operations by converting physical operations by a user, input through the button operation unit 103, into electronic data and communicating that electronic data to the CPU 201.

A card reader I/F 208 is also connected to the I/O controller 203. The card reader I/F 208 implements authentication operations and the like by converting information read from an IC card, input to the card reader unit 104, into electronic data and communicating that electronic data to the CPU 201. A printer I/F 209 is also connected to the I/O controller 203. The CPU 201 implements processing for output onto a paper medium using the printer unit 105 through the printer I/F 209.

A scanner I/F 210 is also connected to the I/O controller 203. The CPU 201 implements processing for reading a document using the scanner unit 106 through the scanner I/F 210. A USB I/F 211 is also connected to the I/O controller 203. The USB I/F 211 controls devices connected to the USB I/F 211.

When implementing a copy function, the CPU 201 loads program data from the Flash memory 221 into the DRAM 202 through the SATA I/F 205. In accordance with the program loaded into the DRAM 202, the CPU 201 detects a copy instruction made by a user on the panel operation unit 102 and the button operation unit 103 through the panel I/F 206 and the button I/F 207. Upon detecting the copy instruction, the CPU 201 receives the document as electronic data from the scanner unit 106 through the scanner I/F 210 and stores the document in the DRAM 202. The CPU 201 performs color conversion processing suited to output on the image data stored in the DRAM 202. The CPU 201 transfers the image data stored in the DRAM 202 to the printer unit 105 through the printer I/F 209, and performs processing for outputting onto the paper medium. As described earlier, the copy function can be realized by combining a printing function and a scanning function.

When implementing a PDL (Page Description Language) printing function, the client PC 110 issues a printing instruction over the LAN 140. The CPU 201 loads program data from the Flash memory 221 into the DRAM 202 through the SATA I/F 205, and detects a printing instruction through the network I/F 204 in accordance with a module loaded into the DRAM 202. Upon detecting a PDL sending instruction, the CPU 201 receives print data through the network I/F 204 and stores the print data in the Flash memory 221 through the SATA I/F 205. Once the print data has been saved, the CPU 201 expands the print data saved in the Flash memory 221 in the DRAM 202 as image data. The CPU 201 performs color conversion processing suited to output on the image data stored in the DRAM 202. The CPU 201 transfers the image data stored in the DRAM 202 to the printer unit 105 through the printer I/F 209, and performs processing for outputting onto the paper medium.

A functional configuration and a processing flow according to the present embodiment will be described below.

### Functional Configuration

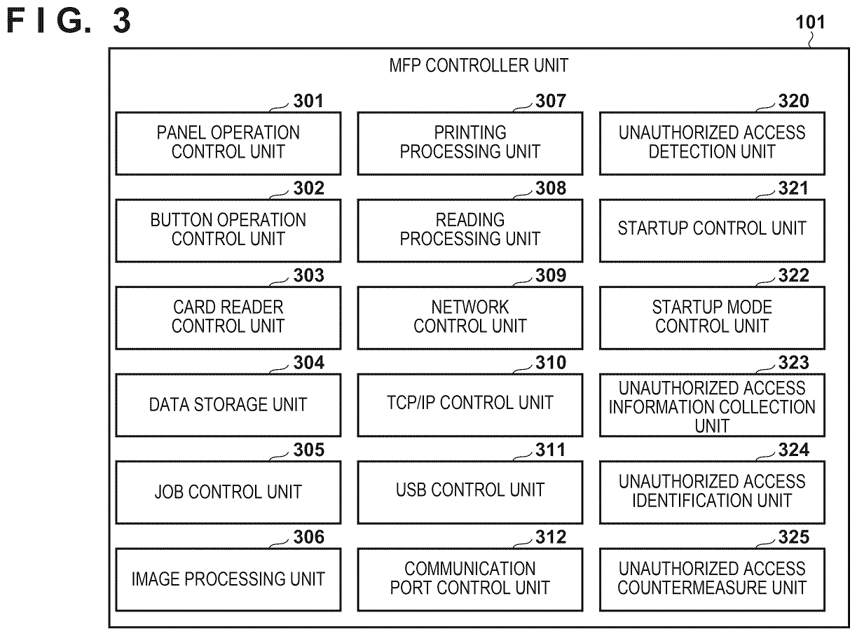

An example of the functional configuration of the controller unit 101 of the MFP 100 according to the first embodiment will be described with reference to FIG. 3. The controller unit 101 includes a panel operation control unit 301, a button operation control unit 302, a card reader control unit 303, a data storage unit 304, a job control unit 305, and an image processing unit 306. The controller unit 101 also includes a printing processing unit 307, a reading processing unit 308, a network control unit 309, a TCP/IP control unit 310, a USB control unit 311, and a communication port control unit 312. The controller unit 101 further includes an unauthorized access detection unit 320, a startup control unit 321, a startup mode control unit 322, an unauthorized access information collection unit 323, an unauthorized access identification unit 324, and an unauthorized access countermeasure unit 325.

The panel operation control unit 301 displays screen images to the user in the panel operation unit 102, detects touch operations by the user, executes processing associated with screen components such as buttons displayed on the screen, and the like. In response to the user pressing a button provided in the button operation unit 103, the button operation control unit 302 executes the processing associated with the button.

The card reader control unit 303 executes processing in accordance with information read by a reader provided in the card reader unit 104 reading an IC card held up to the reader by the user. The data storage unit 304 stores data in the Flash memory 221, reads out data from the Flash memory 221, and the like in response to requests from another control unit. For example, if the user wishes to change some device settings, the panel operation control unit 301 detects the details of inputs made by the user through the panel operation unit 102. The data storage unit 304 the saves the setting values in the Flash memory 221 in response to a request from the panel operation control unit 301.

The job control unit 305 controls the execution of jobs in accordance with instructions from another control unit. The image processing unit 306 processes the image data into a format suited to the purpose thereof in accordance with instructions from the job control unit 305. The printing processing unit 307 prints and outputs an image onto a paper medium through the printer I/F 209 in accordance with instructions from the job control unit 305. The reading processing unit 308 reads a document which has been placed through the scanner I/F 210 in accordance with instructions from the job control unit 305.

The network control unit 309 makes network settings, such as the IP address, in the TCP/IP control unit 310 when the system is started up, when changes to settings are detected, and the like, in accordance with the setting values stored in the data storage unit 304. The TCP/IP control unit 310 performs processing for sending and receiving network packets through the network I/F 204 in response to instructions from another control unit. The USB control unit 311 controls the USB I/F 211, and controls any connected USB devices. The communication port control unit 312 controls the port used by the TCP/IP control unit 310 when sending and receiving packets.

The unauthorized access detection unit 320 detects unauthorized access to the MFP. It is possible for an attacker to perform unauthorized access to the MFP by exploiting unknown vulnerabilities and the like in the MFP. In the case of unauthorized access, the attacker uses the shell of the MFP to execute various commands and unauthorized use of functions.

In response, when behavior not normally exhibited by the MFP has occurred due to an attacker or the like, the unauthorized access detection unit 320 detects that behavior as unauthorized access. In other words, behavior not performed by the MFP when there is no unauthorized access is detected as behavior performed when there is unauthorized access. For example, to perform an attack by tampering with a program or setting values in an MFP, an attacker performs an attack such as launching an editor through the shell of the MFP, or an attack such as executing a search command to find a program targeted by the attacker. Although the MFP has commands that implement the processing described above, those commands are not executed in ordinary use cases.

The unauthorized access detection unit 320 can determine that unauthorized access has occurred when such typical behavior of an attacker, which cannot occur in normal use cases of the MFP, has been detected. Although an example of detecting unauthorized access on the basis of a command not executed in a normal use case of the MFP is described here, the occurrence of unauthorized access may be detected on the basis of the behavior of the system, such as unusual process behavior, libraries being loaded, and the like. Alternatively, AI may be used to detect unusual behavior, which may be detected as unauthorized access. When unauthorized access is detected, the unauthorized access detection unit 320 instructs the startup control unit 321 to perform a restart.

The startup control unit 321 controls the startup and restarting of the MFP. The startup control unit 321 restarts the MFP in response to an instruction from the unauthorized access detection unit 320. This restart makes it possible to cut off at attacker's access. When restarting, the startup control unit 321 instructs the startup mode control unit 322 to shift to a function restricted mode. The function restricted mode will be described in detail later. In addition, when an instruction to cancel the function restrictions is made as a result of an instruction from the unauthorized access countermeasure unit 325 (described later), the startup control unit 321 performs a restart and instructs the startup mode control unit 322 to shift to a normal mode. The normal mode will be described in detail later.

The startup mode control unit 322 controls the startup mode in response to the instructions from the startup control unit 321. The startup mode includes the normal mode and the function restricted mode, and the startup mode control unit 322 selects functions to be enabled according to the selected function mode.

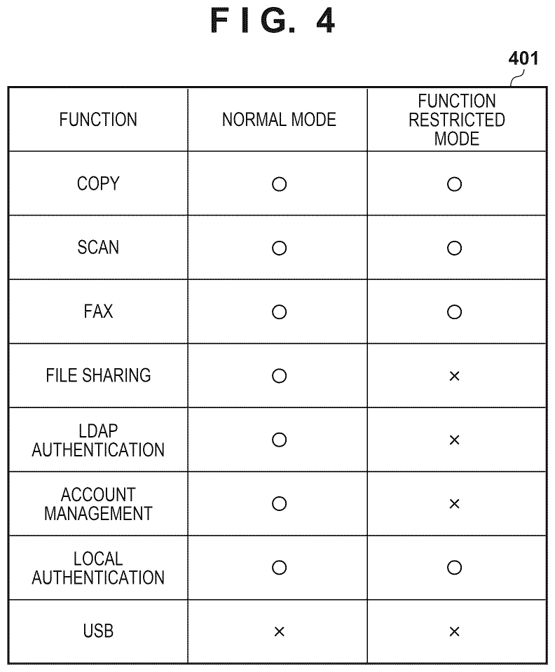

When selecting function to be enabled, a function control table 401, illustrated in FIG. 4, is referenced. The function control table 401 lists functions that can be used in each startup mode. The enabling and disabling of functions set by a user having administrator privileges is reflected in the normal mode. Although all functions are enabled by default in the normal mode, functions disabled through user operations are recorded in the function control table 401 as being in a disabled state. For example, if the user has applied a setting that prohibits USB use, an item pertaining to USB in the function control table 401 is recorded as being in the disabled state. The disabled state in the normal mode is a state in which the use of the function is stopped, and the state can shift to the enabled state when the MFP is started up through a user operation. Note that the functions disabled by the unauthorized access countermeasure unit 325 (described later) also enter the disabled state when shifting to the normal mode.

In the function restricted mode, functions for which use is prohibited are disabled when an attacker performs unauthorized access to the MFP. For example, a file sharing function is a function for sharing files with a client PC by using a Server Message Block (SMB) to utilize the MFP as a server. It is conceivable that an attacker could place a malicious file, such as malware, on the SMB server under the guise of a normal file, and spread the damage to the client PC.

An LDAP authentication function is a function that authenticates the MFP through an LDAP server. Authentication information of MFP users is stored in the LDAP server, and the authentication information is normally used in employee accounts of the company that owns the MFP. Because obtaining an employee account could allow an attacker to access other systems in the company (other devices connected to the MFP) and obtain information, it is conceivable that the attacker could use the LDAP authentication function to launch an attack on the LDAP server.

An account management function can manage the accounts of users who use the MFP, and is a function for performing operations such as changing user privileges and adding accounts. It is conceivable for an attacker to execute an attack such as granting administrator privileges to the account used for unauthorized access to the MFP or adding a new account for the attacker to use. By restricting the functions through which such an attacker can cause major damage by exploiting the functions of the MFP, damage can be prevented from spreading even if the attacker attempts unauthorized access again. Although the functions described above have been given here as examples of the functions to be restricted, other functions that may be exploited by an attacker are similarly subject to the limitation.

On the other hand, basic functions such as copying, scanning, and faxing functions are not expected to be used to spread damage, and thus are not considered functions that can be exploited by an attacker. Accordingly, these functions can be used in the same manner as in the normal mode.

This makes it possible to ensure both security and usability by providing the general functions of the MFP to the user while preventing the spread of damage caused by attackers. In addition, in situations where unauthorized access from a remote environment is expected, using functions that require physical contact with the MFP can be used as normal with no issues, and thus local authentication functions and USB connections can be used.

However, functions prohibited in the normal mode are also prohibited in the function restricted mode. For example, in the function control table 401 illustrated in FIG. 4, the use of USB in the normal mode is prohibited, and this setting is therefore carried over to the function restricted mode. The function restricted mode is a different system configuration from the normal mode, and is a state in which the functions to be restricted are excluded from the system configuration. As such, the restricted functions cannot be enabled while the MFP is running in the function restricted mode. To enable these functions, it is necessary to change the startup mode to the normal mode and then restart the MFP. Therefore, in the function restricted mode, the functions to be restricted are not displayed on the UI, and the user does not have access to those functions.

The unauthorized access information collection unit 323 collects information on the attacker who has made unauthorized access after the shift to the function restricted mode. It is possible that when unauthorized access is detected by the unauthorized access detection unit 320, the attacker will be blocked from access, but will access the MFP again. At that time, the attacker attempts to exploit the functions of the MFP to achieve the purpose of the attack, and thus the unauthorized access information collection unit 323 collects information when the attacker attempts to use functions which have been restricted. Functions which are restricted are excluded from the system configuration and are not used by the user, and thus if some kind of event occurs in the corresponding function, that event can be identified as having been executed by the attacker.

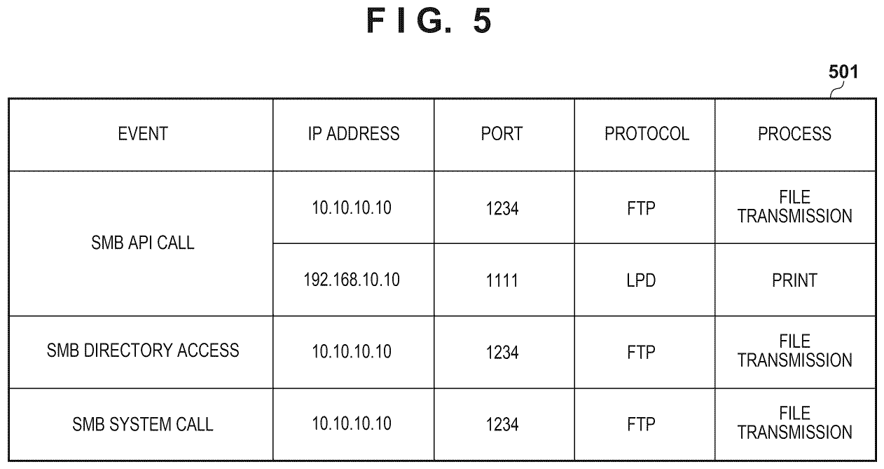

This event can include access to the directory where the binaries of the corresponding functions are located, API calls, system calls, and other events that can occur within the MFP. The unauthorized access information collection unit 323 records a log of these events in an unauthorized access log record table 501 illustrated in FIG. 5. Events occurring when an attempt is made to use a restricted function, the IP address and port used for communication when the event occurs, and information such as the protocol being used, the process being launched, and the like are recorded in the unauthorized access log record table 501.

For example, if an attacker attempts to use the file sharing function which is restricted, the attacker will attempt to use the SMB function. Accordingly, events such as SMB API calls, SMB directory accesses, and SMB system calls, the IP address and port used to access the MFP when that event occurs, the protocol used for communication, the process being launched, and the like are recorded.

When access from a plurality of IP addresses or the use of a protocol is detected when an event occurs, that information is recorded so as to be associated with a single event. For example, when an “SMB API call” event in the unauthorized access log record table 501 illustrated in FIG. 5 occurs, access from two IP addresses is recorded, and both of these are associated with the “SMB API call” event. Although the IP address, port, protocol, and process are listed here as the information recorded in association with the event, other information may be included as well.

The unauthorized access identification unit 324 identifies the source of the unauthorized access on the basis of the information collected by the unauthorized access information collection unit 323. To identify the source of the unauthorized access, the unauthorized access log record table 501 illustrated in FIG. 5 is referenced. The unauthorized access identification unit 324 identifies at least one of the IP address of the attacker who produced the event recorded in the unauthorized access log record table 501, the port used, the protocol, the process, and the like as a characteristic of the attacker.

For example, when an event of “SMB system call” recorded in the unauthorized access log record table 501 occurs, the IP address “10.10.10.10”, the port “1234”, the protocol “FTP”, and the process “file transmission” are recorded. This means that the attacker is accessing from this IP address and port, and is distributing (sending) payloads to exploit the SMB under the guise of an FTP file transmission. The source of the unauthorized access can be identified from the recorded unauthorized access event information in this manner.

In other words, the unauthorized access identification unit 324 identifies the source of the unauthorized access from the state of access to some of the restricted functions. To be more specific, the source of the unauthorized access is identified on the basis of the characteristics of the attacker attempting to access some of the restricted functions. The characteristics of the attacker can include at least one of the IP address, the port, and the protocol used to access the MFP when the event associated with the some of the restricted functions occurred, and the process executed.

Note that there are cases where a plurality of items of related information are recorded, such as the “SMB API call” event in the unauthorized access log record table 501. When a plurality of items of information are recorded at the same time, the source of the unauthorized access is not determined on the basis of a single event, but rather is identified according to relationship among a plurality of events. For example, access from the IP address “10.10.10.10” recorded in the unauthorized access log record table 501 is related to events such as “SMB API call”, “SMB directory access”, “SMB system call”, and the like. On the other hand, access from the IP address “192.168.10.10” is recorded at the time of an “SMB API call”, but does not appear in other events. From this, it can be determined that access from the IP address “192.168.10.10” is access from a user recorded accidentally. In this manner, the source of the unauthorized access can be identified even when an operation has been made by the user. The above example of analysis is merely one example, and the source of the unauthorized access may be identified by correlation analysis between the event that occurred and other information, analysis using AI, or the like.

In addition, the processing for identifying the source of the unauthorized access source is performed when some kind of condition is satisfied, such as when a predetermined number of logs are recorded in the unauthorized access log record table 501, a certain length of time has passed since the first log was recorded, a log that can uniquely identify the source of unauthorized access is recorded, or the like. The settings for the condition for performing the identification processing can be selected by the administrator of the MFP.

The unauthorized access countermeasure unit 325 implements countermeasures to block access from the source of the unauthorized access identified by the unauthorized access identification unit 324. The unauthorized access countermeasure unit 325 blocks access by adding the IP address identified by the unauthorized access identification unit 324 to a deny list of the firewall and closing the identified port. In addition, the interface used in the attack is closed by disabling the protocol used during the attack. This makes it possible to block the source of the unauthorized access by the attacker. Note that the above countermeasures are merely examples, and processing such as prohibiting used processes from being executed may be added as well.

After the unauthorized access countermeasure unit 325 implements the countermeasures, the startup control unit 321 restarts the MFP and instructs the startup mode control unit 322 to shift to the normal mode. The stated instruction is made when any desired condition is satisfied, such as immediately after the countermeasures against unauthorized access are taken, after a certain length of time has passed, when the administrator performs an operation after being notified that the source of the unauthorized access has been identified, or the like. The settings for the condition for making the shift instruction can be selected by the administrator of the MFP. Note that if a new log is recorded in the unauthorized access log record table 501 again before the shift instruction is made, the processing for identifying the source of the unauthorized access is performed again.

### Processing

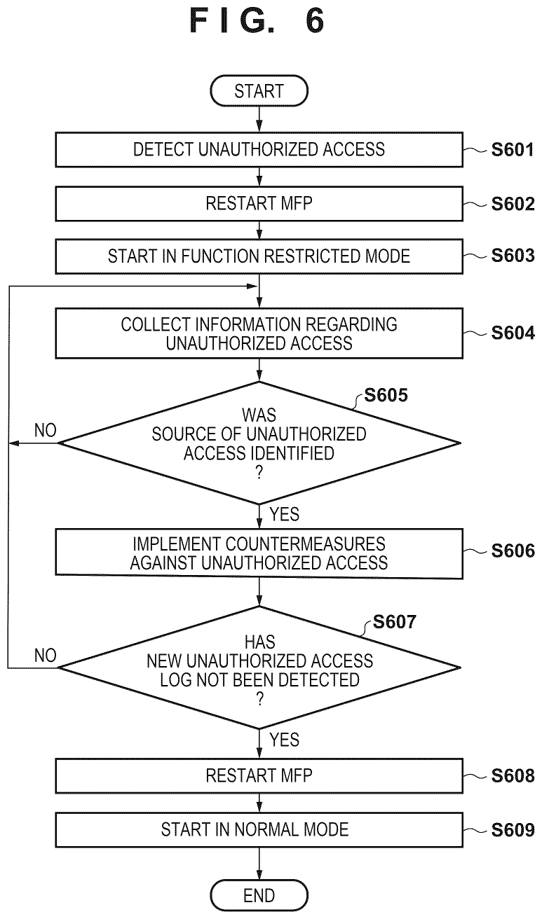

A processing sequence performed by the information processing apparatus (MFP) according to the present embodiment will be described next with reference to the flowchart in FIG. 6. More specifically, a flow for restricting a function exploited by an attacker when unauthorized access is detected, identifying the source of the unauthorized access, and taking countermeasures will be described.

In step S601, the unauthorized access detection unit 320 detects unauthorized access to the MFP. In step S602, the startup control unit 321 blocks the unauthorized access by restarting the MFP. In step S603, the startup mode control unit 322 starts the MFP in the function restricted mode.

In step S604, after the shift to the function restricted mode, the unauthorized access information collection unit 323 collects log information regarding the unauthorized access. In step S605, the unauthorized access identification unit 324 analyzes the log information regarding the unauthorized access and determines whether the source of the unauthorized access has been successfully identified. If the source of the unauthorized access cannot be identified (NO in step S605), the sequence returns to step S604, where the collection of the information continues. On the other hand, if the source of the unauthorized access has been successfully identified (YES in step S605), the sequence moves to step S606.

In step S606, the unauthorized access countermeasure unit 325 implements countermeasures against unauthorized access. In step S607, after the unauthorized access countermeasures are taken, the unauthorized access information collection unit 323 determines whether a new unauthorized access log has been detected during a period set by the administrator. If a new unauthorized access log has been detected (NO in step S607), the sequence returns to step S604, where the log information regarding the unauthorized access is collected until the source of the unauthorized access is successfully identified. If a new unauthorized access log has not been detected during the period set by the administrator (YES), the sequence moves to step S608.

In step S608, the startup control unit 321 restarts the MFP. In step S609, the startup mode control unit 322 starts the MFP in the normal mode. In this manner, the function exploited by the attacker when the unauthorized access is detected is restricted, the source of the unauthorized access is identified, and countermeasures are implemented.

As described above, according to the present embodiment, restricting only functions exploited by an attacker when unauthorized access to the information processing apparatus is detected makes it possible to prevent the spread of damage while maintaining some functions (the basic functions) of the information processing apparatus. Accordingly, it is possible to prevent the spread of damage caused by the unauthorized access while maintaining usability.

### First Variation on First Embodiment

The present variation will describe an example in which tamper detection processing and recovery processing are performed at startup after unauthorized access is detected. The restart processing performed after unauthorized access is detected can block access by the attacker, but it is possible that the attacker tampered with settings, programs, or the like before the unauthorized access was detected. Accordingly, tamper detection that detects tampering with settings, programs, or the like is performed, and recovery processing is performed to overwrite the settings, programs, and the like, which were tampered with, with settings, files, and the like in a normal state, held in advance. This makes it possible to disable the tampering performed by the attacker.

It is necessary to store the settings and programs in the normal state in order to implement the recovery processing. However, a device such as an MFP has a limited area in which such data can be stored, and it is therefore impractical to keep a backup of all the data. Accordingly, the data for recovery is often stored only for important settings and programs. It therefore may not be possible to recover all the settings, programs, and the like that have been tampered with. Functions pertaining to settings, programs, and the like that could not be recovered through the recovery processing may negatively affect the system, and are therefore added as functions to be restricted when shifting to the function restricted mode.

### Functional Configuration

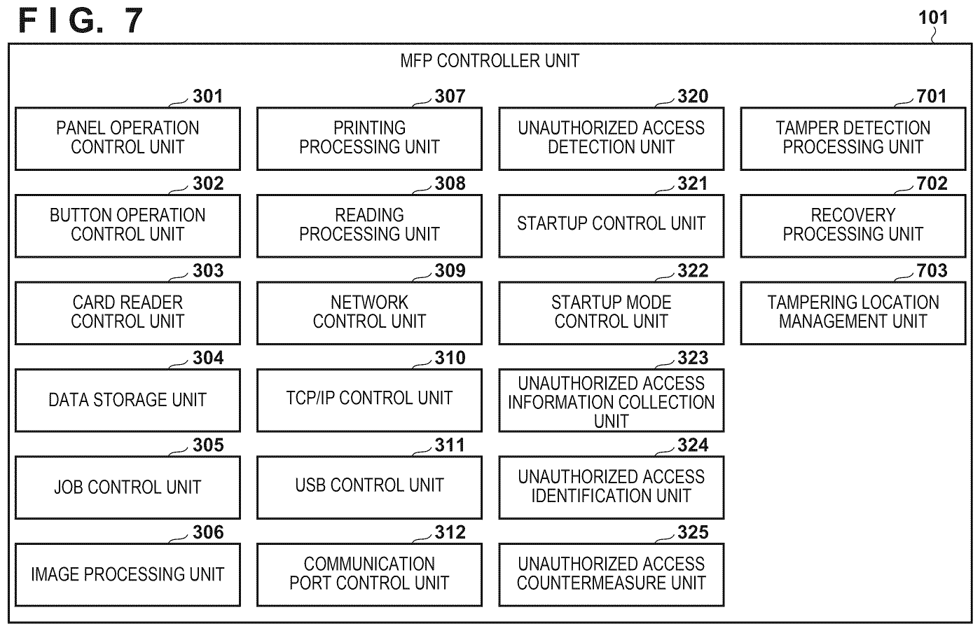

An example of the functional configuration implemented by software executed by the controller unit 101 of the MFP 100 according to the first variation will be described with reference to FIG. 7. Note that in the present variation, configurations that are the same as those described in the first embodiment will be given the same reference signs, and will not be described in detail.

A tamper detection processing unit 701 detects tampering with settings, programs, and the like in the MFP. A hash value calculated from the item for which tampering is to be detected is used for the tampering detection. Hash values calculated from the settings, programs, and the like are recorded as correct values in the Secure memory 222 of the MFP, and the tamper detection processing unit 701 verifies whether tampering has occurred according to whether the hash value calculated from the item for which tampering is to be detected matches the correct value. If the result of the tamper detection processing indicates no tampering has occurred, the mode shifts directly to the function restricted mode. However, if tampering has occurred, a recovery processing unit 702 is instructed to perform recovery processing.

The recovery processing unit 702 recovers settings, programs, and the like detected by the tamper detection processing unit 701 as having been tampered with. The recovery processing is implemented by overwriting the item that has been tampered with settings, programs, and the like in a normal state, stored in advance in the Secure memory 222 of the MFP.

A tampering location management unit 703 manages functions not subject to the recovery processing by the recovery processing unit 702. The tampering location management unit 703 lists settings, files, and the like not subject to the recovery after the recovery processing has been performed, and identifies a function related to those settings, files, and the like. This function has been tampered with by the attacker and may negatively affect the system, and thus the function is added to the function restrictions, after which the mode shifts to the function restricted mode. It should be noted that programs that have been tampered with may negatively affect the system even after countermeasures have been taken against unauthorized access, and such programs are therefore not enabled even when shifting to the normal mode after taking countermeasures against the unauthorized access.

### Processing

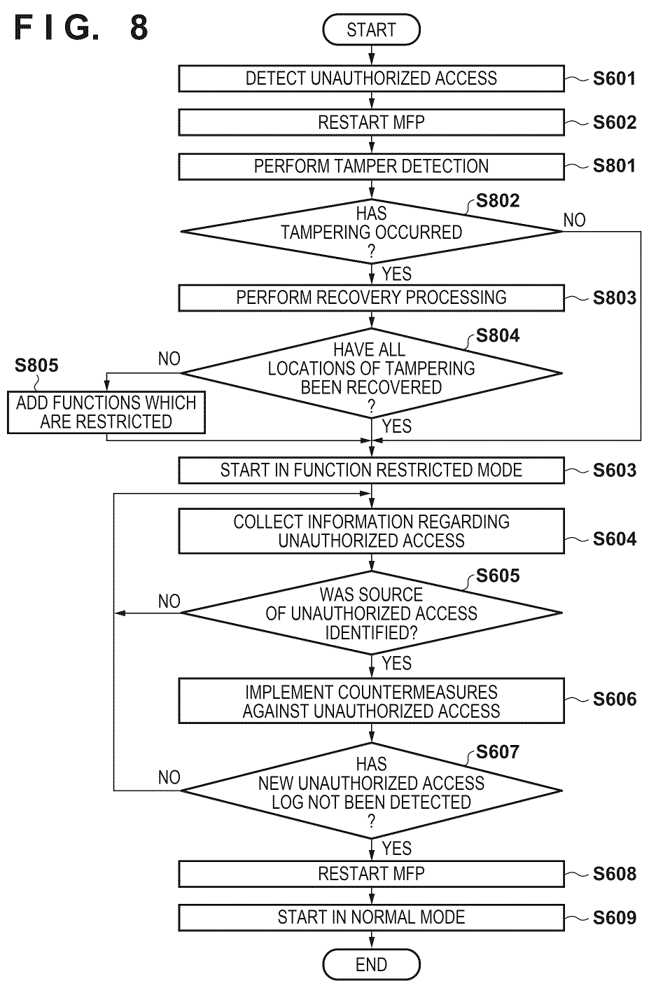

A processing sequence performed by the information processing apparatus (MFP) according to the present embodiment will be described next with reference to the flowchart in FIG. 8. More specifically, a flow for performing tampering detection and recovery processing after detecting unauthorized access, according to the present variation, will be described. Note that in the present variation, processing that is the same as that described in the first embodiment will be given the same reference signs, and will not be described in detail.

In step S801, the tamper detection processing unit 701 performs the tamper detection processing after the MFP is restarted. In step S802, the tamper detection processing unit 701 determines whether tampering has occurred on the basis of the result of the tamper detection processing. If no tampering has occurred (NO in step S802), the sequence moves to step S603, where the mode shifts to the function restricted mode. However, if tampering has occurred (YES in step S802), the sequence moves to step S803.

In step S803, the recovery processing unit 702 performs the recovery processing in response to the tampering. In step S804, the tampering location management unit 703 determines whether all the locations of the tampering have been recovered. If all the locations of the tampering have been recovered (YES in step S804), the sequence moves to step S603, where the mode shifts to the function restricted mode. On the other hand, if there is a function that has not recovered from the tampering (NO in step S804), the sequence moves to step S805. In step S805, the tampering location management unit 703 adds the function that has not recovered from the tampering to the function restrictions, after which the mode is shifted to the function restricted mode in step S603. Processing for performing tampering detection and recovery processing after unauthorized access is detected is implemented in this manner.

As described above, according to the present variation, tampering performed by an attacker can be disabled.

### Second Variation on First Embodiment

The first embodiment described an example of shifting to the function restricted mode after detecting unauthorized access. As opposed to this, the present variation will describe an example in which countermeasures against information leakage are taken when shifting to the function restricted mode.

Print job information, scanned data, and the like are sometimes saved in the storage of an MFP. After shifting to the function restricted mode, even if the attacker infiltrates the MFP again, the attacker cannot spread damage from the MFP to other devices. However, the attacker may be able to access information stored within the MFP. Therefore, if the attacker obtains such information, the information of the company or organization that owns the MFP may be leaked.

Accordingly, after shifting to the function restricted mode, countermeasures against the leakage of information stored within the MFP are taken to prevent the attacker from accessing sensitive information (to protect the sensitive information). Deletion processing for deleting the information itself, or protecting the information through encryption processing, is performed as the countermeasures against the leakage of the information. When performing the deletion processing, the deletion processing is performed after first moving information to a server specified by the administrator of the MFP in advance, the cloud, or the like. When performing the encryption processing, control is performed such that decryption processing can be performed only when shifting to the normal mode, and cannot be performed in the function restricted mode. Whether to delete or encrypt the information can be selected by the administrator. Countermeasures against the leakage of information after unauthorized access is detected are implemented in this manner. Although information such as user IDs, passwords, and the like are also stored in the MFP, such information is protected by the Secure memory 222 and therefore cannot be stolen by an attacker.

As described above, according to the present variation, the information of a company or organization can be prevented from being leaked.

### Third Variation on First Embodiment

The first embodiment described an example in which after shifting to the function restricted mode, the source of unauthorized access is identified, countermeasures are taken, and the mode is then shifted to the normal mode. As opposed to this, the present variation will describe an example in which processing for shifting to the normal mode is performed through a manual operation by the administrator.

Countermeasures against unauthorized access to the MFP may be performed on a system aside from the MFP. For example, if the organization that owns the MFP blocks unauthorized access using a firewall installed in the organization's network, attackers will not be able to access the MFP. In such a case, there is no need for the MFP to identify unauthorized access and take countermeasures, and thus the mode is shifted from the function restricted mode to the normal mode in response to a manual operation by the administrator.

Note that this processing is assumed to be processing executable only from a local UI of the MFP. This is because if it is possible to shift to the normal mode through a remote UI, an attacker may impersonate an administrator to make the shift to the normal mode.

As described above, according to the present variation, there is no need for the MFP to identify unauthorized access and take countermeasures, which makes it possible to suppress unnecessary processing.

According to the present disclosure, when unauthorized access occurs, the spread of damage can be prevented while maintaining some of the functions of the information processing apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-031612, filed Mar. 1, 2024, which is hereby incorporated by reference herein in its entirety.

What is claimed is:

1. An information processing apparatus comprising:
at least one memory storing instructions; and
at least one processor that, upon execution of the stored instructions, is configured to operate as:
a detection unit configured to detect unauthorized access to the information processing apparatus;
a blocking unit configured to block the unauthorized access;
a restricting unit configured to restrict functions of the information processing apparatus;
an identifying unit configured to identify a source of the unauthorized access based on a state of access to the restricted functions;
a countermeasure unit configured to perform a countermeasure based on information on the source of the unauthorized access; and
a canceling unit configured to cancel the restricting of the functions after the countermeasure has been performed.

2. The information processing apparatus according to claim 1,
wherein the detection unit detects behavior not performed by the information processing apparatus when there is no unauthorized access as behavior performed during unauthorized access.

3. The information processing apparatus according to claim 1,
wherein the blocking unit blocks the unauthorized access by restarting the information processing apparatus.

4. The information processing apparatus according to claim 1,
wherein the restricting unit restricts functions by disabling the functions to be restricted.

5. The information processing apparatus according to claim 1,
wherein the restricted functions include a function of obtaining information from another apparatus connected to the information processing apparatus.

6. The information processing apparatus according to claim 1,
wherein the restricted functions include a function of distributing a payload to another apparatus connected to the information processing apparatus.

7. The information processing apparatus according to claim 1,
wherein the identifying unit identifies the source of the unauthorized access based on a characteristic of an attacker attempting to access the at least one of the restricted functions.

8. The information processing device according to claim 7,
wherein the characteristic of the attacker includes one or more of an IP address, a port, and a protocol used to access the information processing apparatus, and a process executed when an event associated with the functions restricted by the restricting unit occurred.

9. The information processing apparatus according to claim 1,
wherein the countermeasure unit adds an IP address of the source of the unauthorized access to a deny list of a firewall.

10. The information processing apparatus according to claim 1,
wherein the countermeasure unit closes a port of the source of the unauthorized access.

11. The information processing apparatus according to claim 1,
wherein the countermeasure unit disables a protocol of the source of the unauthorized access.

12. The information processing apparatus according to claim 3, further comprising:
a tamper detection unit that performs tamper detection processing after the information processing apparatus restarts.

13. The information processing apparatus according to claim 12, further comprising:
a recovery unit that performs recovery processing when the tampering has been detected by the tamper detection unit.

14. The information processing apparatus according to claim 1,
wherein the countermeasure unit performs a countermeasure against leakage of sensitive information stored in the information processing apparatus after the functions have been restricted.

15. The information processing apparatus according to claim 1,
wherein the canceling unit cancels restrictions of the restricted functions based on a manual operation by an administrator.

16. The information processing apparatus according to claim 1,
wherein the information processing apparatus is an image forming apparatus.

17. A control method for an information processing apparatus, the control method comprising:
detecting unauthorized access to the information processing apparatus;
blocking the unauthorized access;
restricting functions of the information processing apparatus;
identifying a source of the unauthorized access based on a state of access to the restricted functions;
taking a countermeasure based on information on the source of the unauthorized access; and
canceling the restricting of the functions after the countermeasure has been performed.

18. A non-transitory computer-readable storage medium having stored therein a program for causing a computer to execute a control method for an information processing apparatus, the control method comprising:
detecting unauthorized access to the information processing apparatus;
blocking the unauthorized access;
restricting functions of the information processing apparatus;
identifying a source of the unauthorized access based on a state of access to the restricted functions;
taking a countermeasure based on information on the source of the unauthorized access; and
canceling the restricting of the functions after the countermeasure has been performed.
